(19) United States
(12) Patent Application Publication
(10) Pub. No.: US 2019/0082626 A1
(43) Pub. Date: Mar. 21, 2019

(54) PULSED HYDROPONIC AGRICULTURAL GROWTH SYSTEMS AND METHODS

(71) Applicant: Grow Big Technologies, LLC, Koloa, HI (US)

(72) Inventor: Mark Jeff Zeldes, Brentwood, CA (US)

(21) Appl. No.: 16/136,172

(22) Filed: Sep. 19, 2018

Related U.S. Application Data
(60) Provisional application No. 62/560,592, filed on Sep. 19, 2017.

(51) Int. Cl. A01G 31/02; A01G 7/04; A01G 29/00

(52) U.S. Cl. CPC A01G 31/02; A01G 29/00; A01G 7/045

(57) ABSTRACT

A system for pulsed hydroponic plant growth without using a media substrate to support plant roots includes a growth platform, a mixing tank, and a hydraulic delivery system, wherein the growth platform is shaped to form multiple apertures, each configured to support a growth ring, and the hydraulic delivery system includes sensors, a high pressure pump, multiple inline valves, and multiple micro-sprayers, the high pressure pump, inline valves, and micro-sprayers being hydraulically coupled to the mixing tank. The mixing tank is configured to combine nutrients in water to generate a nutrient solution for a nutrient solution mist for release through micro-sprayers located in proximity to one or more growth rings, and the hydraulic delivery system is configured to pulse the release of the nutrient solution mist during a feeding cycle at a selected pulse-width.

### TECHNICAL FIELD

The disclosed technology relates generally to agriculture, and more particularly to hydroponic agricultural grown systems and methods.

### BACKGROUND

Technologies for growing plants outside of a soil-based medium, referred to herein as hydroponics, generally incorporate a non-soil growth substrate to support the plant roots and assist in the delivery of water and nutrients required for plant growth. For example, growth substrates may include rock wool, hydroughton, perlite, vermiculite, clay pellets, sand, gravel, or sawdust. Using these types of growth substrates increases the cost and weight of the hydroponic systems, and decreases efficiency of delivery of water and nutrients to the plant. In particular, growth substrates retain at least some of the moisture and nutrients intended for delivery to the roots. Water may evaporate from the growth substrate, and nutrients may bind to the growth substrate instead of being absorbed into the roots system or otherwise consumed by the plant. As a result, plant growth is attenuated and yield is limited.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates a schematic diagram of a system for pulsed hydroponic plant growth without using a media substrate to support plant roots, consistent with embodiments disclosed herein.

FIG. 2 illustrates a perspective view of a feeding tank, consistent with embodiments disclosed herein.

FIG. 3 illustrates a perspective view of a feeding tank, consistent with embodiments disclosed herein.

FIG. 4 illustrates a schematic diagram of a feeding tank, consistent with embodiments disclosed herein.

FIG. 5 illustrates a schematic diagram of a feeding tank, consistent with embodiments disclosed herein.

FIG. 6 is a flow chart illustrating an example method for transferring plants to different growth frames to accommodate maturing plants grown in a system for pulsed hydroponic plant growth, consistent with embodiments disclosed herein.

FIG. 7 is a flow chart illustrating a method for pulsed hydroponic plant growth without a media substrate to support plant roots, consistent with embodiments disclosed herein.

FIG. 8A is a perspective view of a growth platform, consistent with embodiments disclosed herein.

FIG. 8B is a perspective view of a growth frame, consistent with embodiments disclosed herein.

FIG. 9 illustrates an example computing system that may be used in implementing various features of embodiments of the disclosed technology.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

Systems and methods for pulsed hydroponic plant growth without a growth substrate are provided. In some embodiments, a system for pulsed hydroponic plant growth without a substrate includes a growth platform configured to support multiple growth frames. A growth frame may include a support structure configured to support a plant with the stem and leaf structure of the plant growing in a first direction and the root structure growing in a second direction. The growth frames may be ring shaped, and may include a cup structure on one side of the ring configured to support or hold in place the root structure of a plant. The cup structure may include multiple apertures to enable water and nutrients to pass through the cup structure and onto the root structure of the plant. The growth frames may be fabricated from plastic, metal, ceramic, composite material, rubber, or other rigid or semi-rigid materials.

The growth platform may be shaped to form multiple apertures shaped to match an outer profile of the growth frames. For example, if the growth frames are ring shaped, then the apertures would be circular and sized with a diameter that is substantially the same as the outer diameter of the growth frame. The apertures may include lip or tab structures with smaller diameters than the outer diameter of the growth frame as to support the growth frames.

A system for pulsed hydroponic plant growth may also include a liquid and nutrient deliver system. For example, the liquid and nutrient deliver system may include a mixing tank, a hydraulic delivery system, a high pressure pump, a controller, an electromagnetic radiation delivery system, and multiple atomizing nozzles. In some examples, the mixing tank is configured to accept water and one or more nutrients (e.g., fertilizer, plant food, pH stabilizers, etc.), and mix the nutrients with the water to generate a nutrient solution. The hydraulic delivery system may couple the mixing tank, through the high pressure pump and one or more valves, to the atomizing nozzles. The atomizing nozzles may be positioned to direct a high pressure atomized spray towards one or more plants supported by the growth frames in the growth platform. As used in the present disclosure, high pressure may include pressures greater than 500 pounds per square inch.

In some examples, the hydraulic delivery system includes a series of pipes coupling the mixing tank to the high pressure pump, through multiple inline valves, and to the atomizing nozzles. The atomizing nozzles may be conical and decrease in diameter as to atomize a high pressure liquid into a mist of liquid droplets. In an example, the mist includes 1000 droplets per square millimeter. The hydraulic system may be divided into multiple segments. For example, the system may include an upper segment positioned to deliver a nutrient atomized mist to an upper portion of each plant located on a first side of the growth frame. The system may also include a lower segment positioned to deliver the nutrient atomized mist to a lower portion of each plant (i.e., the root structure) located on a second side of the growth frame.

The inline valves and high pressure pump may be coordinated by the controller. For example, the controller may close the inline valves and enable the high pressure pump subsequent to the nutrients and water being mixed. In this example, the high pressure pumps may be Peristaltic pumps. However, other materials used to compose the high pressure pumps that have a longer run time may be coordinated by the controller. Sensors located in the hydraulic delivery system may monitor the nutrient solution for pressure, temperature, pH, and/or other environmental conditions. The controller may receive an environmental condition signal from one or more of the sensors. The controller may also be configured to open the inline valves closest to the atomizing nozzles when the environmental condition signal indicates that pressure is sufficiently high (e.g., above a threshold pressure). In some examples, the threshold pressure may be greater than 900 pounds per square inch. In other example embodiments, the pressure may be between 50 and 100 pounds per square inch. Yet, in other examples, the pressure may be between 100 and 900 pounds per square inch. In some examples, pressure may be varied between the low, medium, and high pressure ranges by a controller configured to adjust pressure based on pre-programmed timers, user input via a graphical user interface (GUI), and/or input from environmental sensors located in the system.

The controller may cause the inline valves to open and close in a pulsed sequence, such that the nutrient mist is sprayed on the plants in pulses. Each pulse may last for a predetermined time, referred to herein as a pulse-width. For example, the pulse-width may be between 100 milliseconds and 10 seconds. In some examples, the pulse-width may be between 1 second and 5 seconds. In some examples, the pulse-width may be randomized or determined according to an algorithm. The algorithm may be used to control and vary pulse rate. For example, the pulse rates may be rapid, e.g., at 1 second or sub-second intervals. In some examples, pulse rates may be moderate, e.g., over several minute or hour intervals. In some examples, pulse rates may be slow, e.g., multi-hour intervals. Pulse rate and pulsation profiles may vary according to the type of high pressure pump. In turn, the algorithm may be used to find optimal pulse rate and pulsation profile for different types of high pressure pumps. In some examples, pulse rates may be varied between the fast, moderate, and slow ranges by a controller configured to adjust pulse rate based on pre-programmed timers, user input via a graphical user interface (GUI), and/or input from environmental sensors located in the system.

The controller may cause the inline valves to enable a predetermined number of pulses for a particular feeding cycle, referred to herein as a cycle width. For example, the cycle width may be between 10 and 100 pulses. In some examples, the nutrient mist may be delivered from only one segment of the hydraulic delivery system for a given cycle. In some examples, the nutrient mist may be delivered from two or more segments of the hydraulic deliver system at the same time (for example, both top and bottom segments at the same time). The controller may cause the inline valves to enact one or more cycles in a day. In some embodiments, the controller may cause the inline valves to enact between eight and twenty-four cycles in a day.

The controller performs the functions of: controlling pulse rates, positioning sensors, adjust temperatures, modifying ambient controls, implementing mixing procedure for nutrient solutions (e.g., the order and amounts of nutrients to add, the amount of time allotted for mixing, etc.), and increasing or decreasing the pH of solutions. These functions performed by the controller allow for pulsed hydroponic plant growth without a growth substrate via automation. Pulse rates, concentration and contents of the nutrient solutions, time of mist delivery, and pH range can vary for different plant types. Additionally, it is essential that the same pulse rates, concentration and contents of the nutrient solutions, time of mist delivery, and pH ranges are used in all instance of growing certain plant type. Manually controlling parameters, such as nutrient mist spraying, may not lead to optimal or even sufficient nutrient feed conditions for certain plants. Pulsed sequences are used to reduce variably while maintaining a sufficient and even optimal nutrient feed conditions.

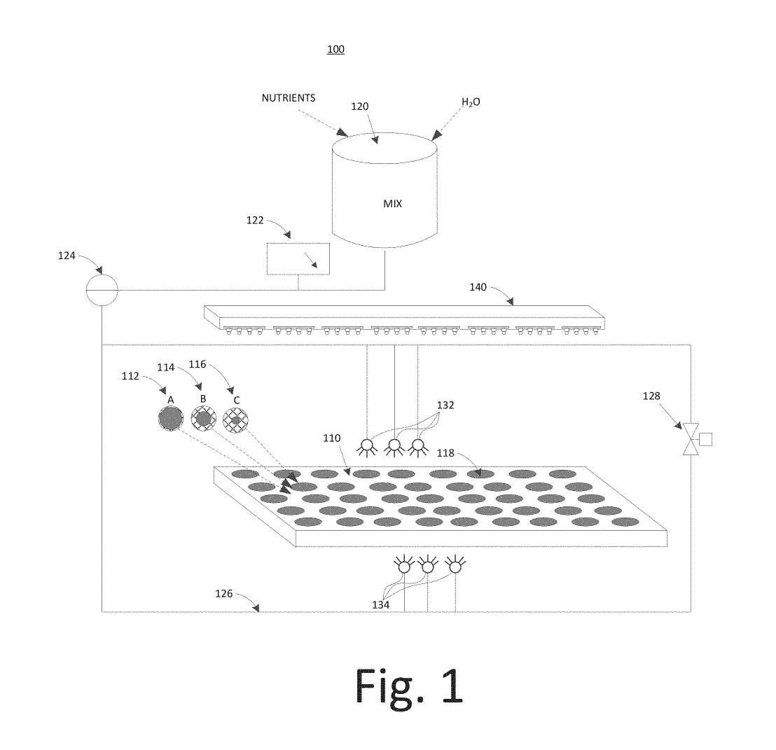

FIG. 1 illustrates a schematic diagram of a system for pulsed hydroponic plant growth without a media substrate to support plant roots. For example, a system 100 for pulsed hydroponic plant growth without a media substrate to support plant roots may include a growth platform 110, a mixing tank 120, a nutrient delivery system 126, a high pressure pump 124, multiple atomizing nozzles 132 and 134, and an electromagnetic delivery system 140. In some embodiments, growth platform 110 may include multiple apertures 118 shaped to hold one or more growth frames. For example, the growth frames (e.g., growth frames 112, 114, and 116) may be sized with outer dimensions to securely support the growth frame within an aperture 118, but with varying sizes of inner dimensions shaped to securely support plants of varying corresponding sizes. A smaller inner dimension, C, in growth frame 116 may be used to support younger plants, e.g., seedlings started in a cloner. A larger inner dimension, B, in growth frame 114 may be used to support maturing plants, and a largest inner dimension, A, in growth frame 112 may be used to support adult plants. The growth frames may be interchangeable, and each growth frame may have a similar outer dimension to be supported in approximately the same location in the growth platform 110, i.e., in aperture 118.

In some embodiments, a cloner may include one or more enclosures configured (e.g., a set of cloner enclosures) to encapsulate the growth frames. The set of cloner enclosures may be fabricated from plastic, metal, composite, or other rigid or semi-rigid materials. In some examples, the cloner enclosures may be fabricated using polyethylene or high density polyethylene. The cloner enclosures may include a top surface that is rounded or beveled. In some examples, the top surface may be a dome-shape. The enclosed environment may be sealed or partially sealed to maintain a controlled internal atmospheric condition, e.g., with respect to humidity, pressure, or other environmental conditions. In some examples, the cloner enclosures include a bottom portion to encapsulate the root structure. The bottom portion may be large enough to accommodate a rapid root growth within the cloner. In some examples, the bottom portion may be more than 12 inches deep (i.e., in the dimension extending downward from the surface of the growth frame). In some examples, the top portion and the bottom portion may have the same or similar depth dimensions. The cloner enclosures may be box shaped, cylindrical, or other shapes as known in the art. In some examples, the cloner enclosures may include one or more spring structures configured to apply force to a surface of the enclosure, or a surface disposed within the enclosure, to cause the surface to contact the root structure and accommodate plants that are smaller than the internal capacity of the cloner enclosure.

In some embodiments, growth platform 110 may also include one or more enclosures (e.g., a set of growth platform enclosures) to encapsulate the growth frames. The growth platform enclosures may be fabricated from plastic, metal, composite, or other rigid or semi-rigid materials. In some examples, the growth platform enclosures may be fabricated using polyethylene or high density polyethylene. The growth platform enclosures may include a top surface that is rounded or beveled. In some examples, the top surface may be a dome-shape enclosed environment may be sealed or partially sealed to maintain a controlled internal atmospheric condition, e.g., with respect to humidity, pressure, or other environmental conditions. In some examples, the growth platform enclosures include a bottom portion to encapsulate the root structure. The bottom portion may be large enough to accommodate the root structure of mature plants. In some examples, the bottom portion may be about 14 inches deep or more. In some examples, the top portion and the bottom portion may have the same or similar depth dimensions. The growth platform enclosure may be box shaped, cylindrical, or other shapes as known in the art. In some examples, the growth platform enclosures may include one or more spring structures configured to apply force to a surface of the enclosure, or a surface disposed within the enclosure, to cause the surface to contact the root structure. In some examples, the cloner enclosures may include one or more spring structures configured to apply force to a surface of the enclosure, or a surface disposed within the enclosure, to cause the surface to contact the root structure and accommodate plants that are smaller than the internal capacity of the growth platform enclosure.

Still referring to FIG. 1, system 100 may also include multiple inline valves 128 positioned to allow pressure to build within nutrient delivery system 118 when high pressure pump 124 is enabled. Some inline valves, closest tow atomizing nozzles 132 and 134, may be opened and closed in sequence to allow a high pressure mist of nutrient solution to exit the atomizing nozzles and be directed towards plants supported in growth platform 110. Inline valves 128 are able to support pressure buildups between 50 to 100 pounds per square inch. Proportioning valves may also be implemented with the inline valves 128. System 100 may also include one or more environmental sensors 122 configured to monitor environmental conditions within nutrient delivery system 126, including pressure, pH, temperature, or other conditions of interest. In some embodiments, system 100 may also include one or more feeding tanks hydraulically coupled to nutrient delivery system 126 to store the nutrient solution in preparation for delivery through the atomizing nozzles 132 and 134.

In some examples, one or more of the environmental sensors 122 may include a multi-sensor structure. For example, the multi-sensor structure may be a rod structure. The rod structure may include an enclosure fabricated from acrylic, glass, ceramic, or other rigid or semi-rigid materials. The rod multi-sensor structure may include a photoionization detector for detecting gases at the parts per million (PPM) scale, pH sensor, a temperature sensor, an oxygen sensor, or other sensors as known in the art. The enclosure may be fabricated from a translucent material (e.g., clear acrylic, glass, or ceramic) to enable the use of light sensors, e.g., to detect temperature using infrared, or measure other environmental parameters in the water or nutrient solution. For example, the opacity of the solution may be relevant to determining the nutrient composition in real time. By quantifying opacity, spectroscopic measurements can be made to determine the nutrient composition and even compositions. In some examples, the multi-sensor structure may include an optical sensor, including a light sensor, and digital camera, or other environmental sensors as known in the art.

Electromagnetic delivery system 140 may be one or more light sources. For example, a light source may deliver artificial light in a desired range of wavelengths tuned to enable and enhance photosynthesis in the plants supported in growth platform 110. The light sources may be positioned to direct light towards plant structures supported by growth platform 110.

In some embodiments, a controller may be electronically coupled to one or more of the inline valves 128, the high pressure pump 124, and/or the environmental sensors 122. In other embodiments, the controller may also be electronically coupled to electromagnetic delivery system 140. For example, the logical circuit may include a processor and a non-transitory computer readable medium with computer executable instructions embedded thereon, the computer executable instructions configured to cause the processor to obtain an environmental condition signal from environmental sensor 122.

The computer readable instructions may also be configured to enable high pressure pump 124 to create a high pressure condition within nutrient deliver system 126, and then release nutrient solution through atomizing nozzles 132 and/or 134 by opening and closing inline valves 128 in a desired sequence. In some embodiments, the desired sequence directs a pulsed atomized mist of nutrient solution through atomizing nozzles 132 and 134 towards the plant structures supported by growth platform 110. The controller may also cause the pulsed sequence to cycle at a set or variable interval. In some examples, parameters to control the pulse sequences and cycle times, e.g., pulse-widths and cycle-widths, may be configured from a user interface. The parameters may also include target pressure, pH, temperature, nutrient concentration, cycle width, and/or pulse-width, or other environmental parameters.

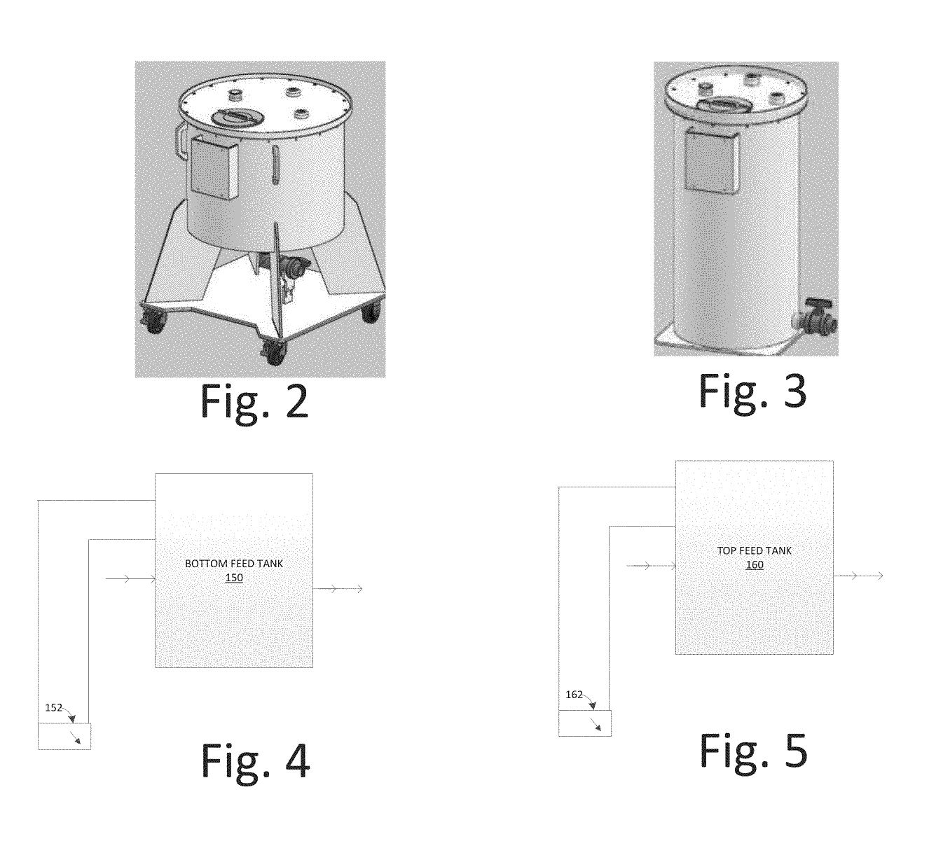

FIGS. 2 and 3 illustrate perspective views of example feeding tanks. The feeding tanks may be hydraulically coupled to nutrient delivery system 126. In some embodiments, separate feeding tanks may be hydraulically coupled to different segments of the nutrient delivery system. For example, a first feeding tank may be coupled to a first segment of the nutrient deliver system and a second feeding tank may be coupled to a second segment of the nutrient delivery system. In some examples, the first segment may be a bottom segment configured to deliver a nutrient mist to a bottom portion of plant structures, for example, as illustrated in FIG. 4. In some examples, the second segment may be a top segment configured to deliver a nutrient mist to a top portion of plant structures, for example, as illustrated in FIG. 5. Each feeding tank may be hydraulically coupled to separate environmental sensors, e.g., 152 and 162, respectively. In some embodiments, the feeding tanks may be connected to a chiller for increased temperature control capabilities.

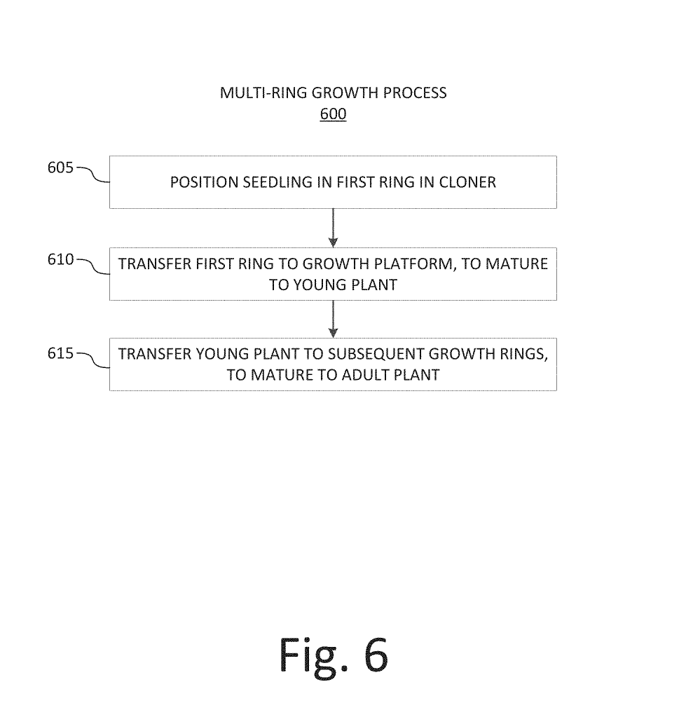

FIG. 6 is a flow chart illustrating an example method for transferring plants to different growth frames to accommodate maturing plants grown in a system for pulsed hydroponic plant growth. As illustrated in FIG. 6, a multi-ring growth process 600 may include positioning a seedling in a first growth ring (e.g., a growth frame) at step 605. In some examples, the first growth ring may be used to transfer the seedling from a cloner to a growth platform at step 610. The maturing plant may be transferred to subsequent growth rings (e.g., growth frames) at step 615. Step 615 may be iterated multiple times as the plant grows, and requires growth rings with larger inner diameters to support the maturing plant structure.

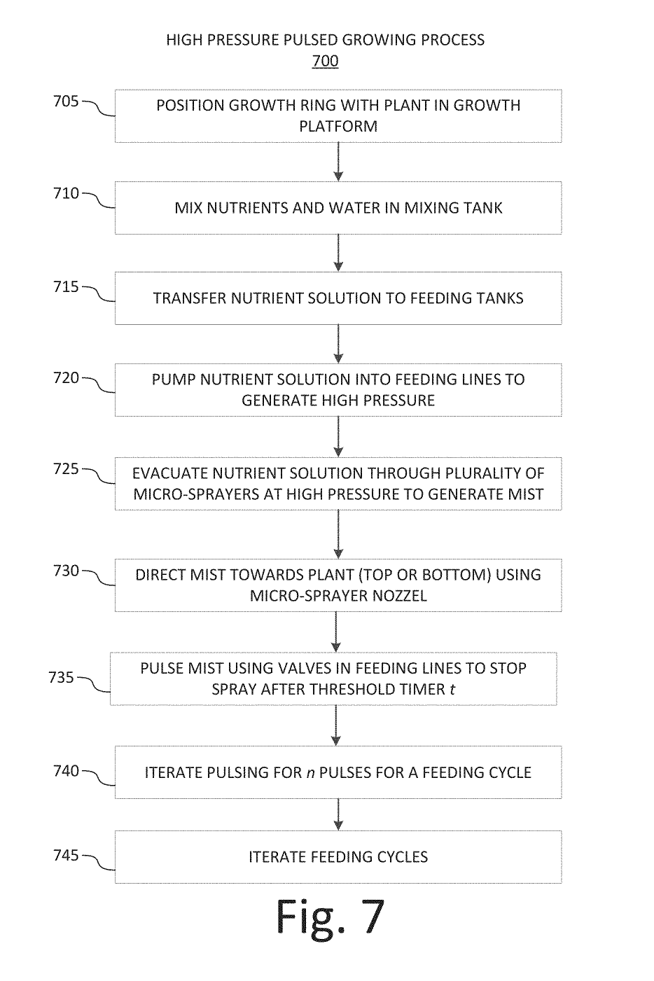

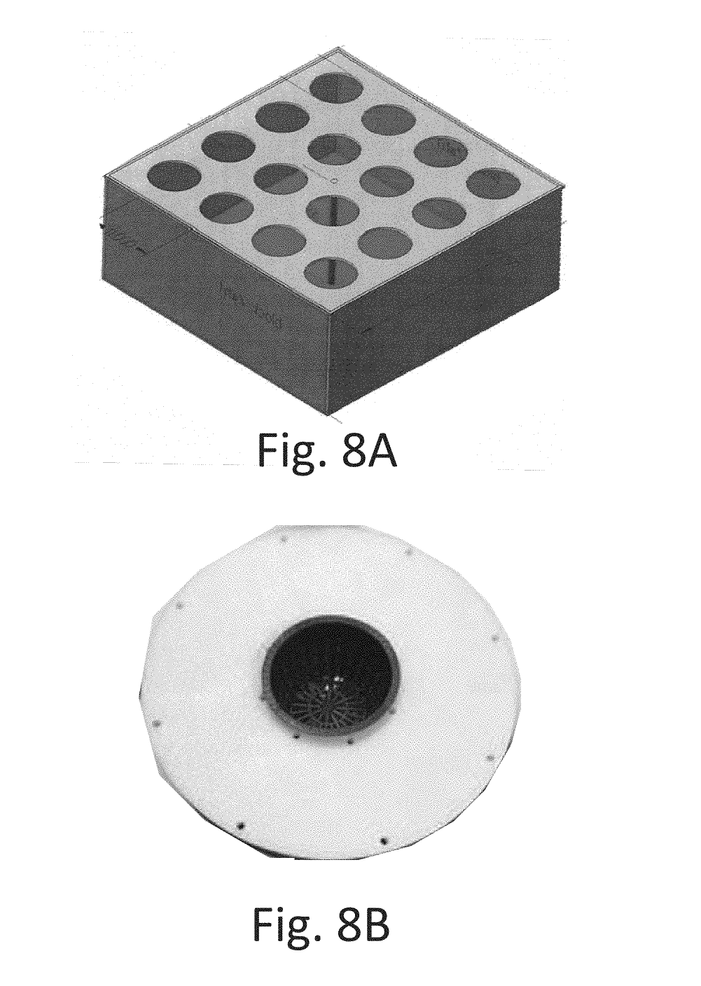

FIG. 7 is a flow chart illustrating a method for pulsed hydroponic plant growth without a media substrate to support plant roots. As illustrated in FIG. 7, a method for high pressure pulsed growing of agricultural products 700 may include positioning multiple growth rings in a growth platform at step 700. A plant may be disposed within a growth ring. The growth rings may support varying plant sizes and maturity levels as described herein with respect to FIG. 6.

In some embodiments, method 700 may include mixing nutrients and water in a mixing tank at step 710. For example, nutrients may include fertilizer, plant food, pH adjusters or stabilizers, macro nutrients, micro nutrients, or other plant growing supplements as known in the art. The mixing may occur in advance of a feeding cycle. In some examples, the mixing may be a “just-in-time” process such that nutrients are kept separate from water until just before the time they will be delivered in a nutrient solution to the plants. This “just-in-time” type of mixing may lead to concentration gradients which can more effectively feed the plant upon delivery to the plants.

Still referring to FIG. 7, method 700 may also include transferring the nutrient solution to one or more feeding tanks at step 715. Feeding tanks may store nutrient solution prior to delivery to the plants. In some examples, separate feeding tanks may be used to store nutrient solution intended for different segments of a nutrient delivery system (e.g., a segment for delivering nutrient solution to a top portion of the plants and a segment for delivering nutrient solution to a bottom portion of the plants). Separate feeding tanks may also be used to store nutrient solution intended for different feeding cycles. In some examples, different mixes of nutrient solution may be used in different feeding tanks to optimize the nutrient component ratio, proportions of nutrient components, or types of nutrient components for particular plant types, plant ages, or times of day. In some examples, the nutrient solution composition may be adjusted based on data obtained from environmental sensors monitoring conditions of the nutrient solution.

In some embodiments, method 700 may also include pumping the nutrient solution into feeding lines (e.g., portions of a nutrient delivery system) to generate high pressure inside the feeding lines at step 720. The nutrient solution may then be evacuated through a plurality of micro-sprayers (e.g., atomization nozzles) at high pressure to generate a mist at step 725. For example, the nutrient solution may be selectively released through different micro-sprayers using inline valves disposed within the feeding lines. By creating a high pressure environment (e.g., more than 500 pounds per square inch, and in some examples, more than 900 pounds per square inch), the nutrient solution may be atomized through the distal ends of the micro-sprayers to create a nutrient solution mist with droplet sizes of less than 10 um in diameter. The nutrient solution mist may be directed towards plant structures (e.g., root systems or stem systems) at step 730, for example, by positioning the micro-sprayer nozzles.

In some examples, the nutrient solution mist may be pulsed at step 735, for example, by opening and closing the inline valves that control release of nutrient solution through the micro-sprayers. The pulsing may also be controlled by alternating segments of the nutrient delivery system to which nutrient solution is directed using an articulating diverter, or using other pulsing methods as known in the art. The pulse-width may be consistent with the pulse-width described herein with respect to FIG. 1. The pulsing may be iterated multiple times in a feeding cycle at step 740 and the feeding cycles may be iterated according to a desired schedule at step 745, consistent with cycle widths described herein with respect to FIG. 1. By pulsing the nutrient solution mist at high pressure (e.g., between 50 to 100 pounds per square inch) towards plant structures, and cycling the feeding cycles, the plant root systems and other plant structures may be kept fed and hydrated, without overfeeding or overhydrating, in the absence of a substrate medium. Accordingly, growing efficiency is increased while minimizing hydraulic and nutrient waste. Maintaining a desired pH balance, environmental conditions, and nutrient composition, the nutrient solution may be evacuated through the micro-sprayer nozzles at an optimal rate without experiencing nutrient lock-up, e.g., a condition where nutrients may precipitate out of solution or suspension and deposit on internal components of the nutrient delivery system, and reduce the performance of the nutrient delivery system.

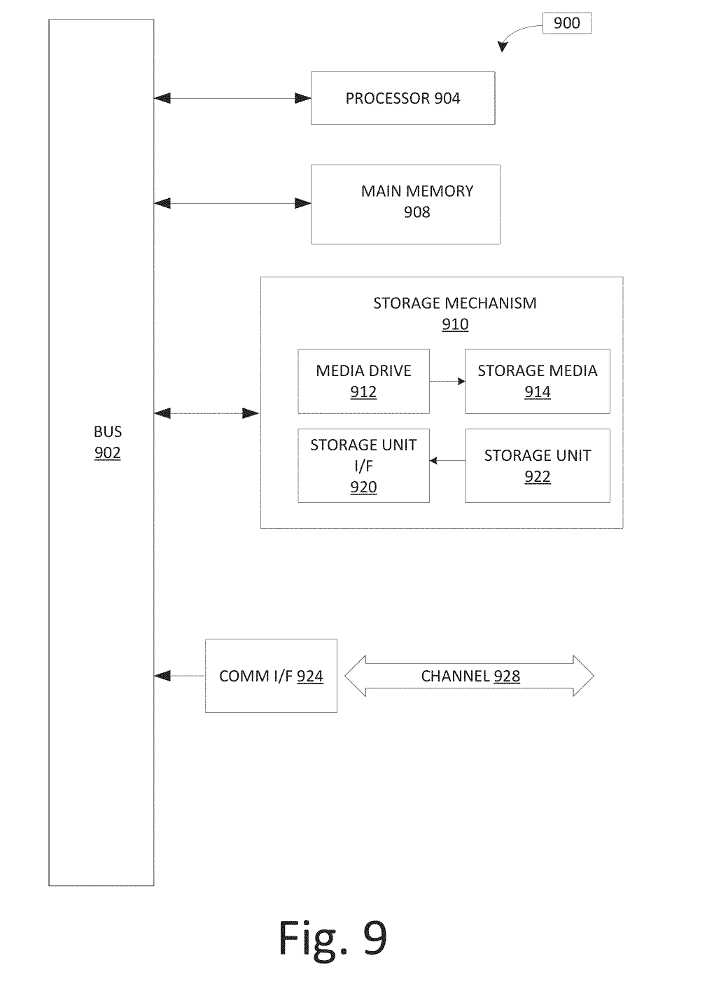

As used herein, the term engine or logical circuit might describe a given unit of functionality that can be performed in accordance with one or more embodiments of the technology disclosed herein. For example, the controller described herein may be implemented using an engine or a logical circuit. As used herein, an engine or logical circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up an engine. In implementation, the various engines described herein might be implemented as discrete engines or the functions and features described can be shared in part or in total among one or more engines. In other words, as would be apparent to one of ordinary skill in the art after reading this description, the various features and functionality described herein may be implemented in any given application and can be implemented in one or more separate or shared engines in various combinations and permutations. Even though various features or elements of functionality may be individually described or claimed as separate engines, one of ordinary skill in the art will understand that these features and functionality can be shared among one or more common software and hardware elements, and such description shall not require or imply that separate hardware or software components are used to implement such features or functionality.

Where components or engines of the technology are implemented in whole or in part using software, in one embodiment, these software elements can be implemented to operate with a computing or processing engine or logical circuit capable of carrying out the functionality described with respect thereto. One such example computing engine or logical circuit is shown in FIG. 9. Various embodiments are described in terms of this example computing engine or logical circuit 900. After reading this description, it will become apparent to a person skilled in the relevant art how to implement the technology using other computing engines, logical circuits, or architectures.

Referring now to FIG. 9, computing system 900 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing engine or logical circuit 900 might also represent computing capabilities embedded within or otherwise available to a given device. For example, a computing engine or logical circuit might be found in other electronic devices such as, for example, digital cameras, navigation systems, cellular telephones, portable computing devices, modems, routers, WAPs, terminals and other electronic devices that might include some form of processing capability.

Computing system 900 might include, for example, one or more processors, controllers, control engines, or other processing devices, such as a processor 904. Processor 904 might be implemented using a general-purpose or special-purpose processing engine such as, for example, a microprocessor, controller, or other control logic. In the illustrated example, processor 904 is connected to a bus 902, although any communication medium can be used to facilitate interaction with other components of computing engine or logical circuit 900 or to communicate externally.

Computing system 900 might also include one or more memory engines, simply referred to herein as main memory 908. For example, preferably random access memory (RAM) or other dynamic memory, might be used for storing information and instructions to be executed by processor 904. Main memory 908 might also be used for storing temporary variables or other intermediate information during execution of instructions to be executed by processor 904. Computing engine or logical circuit 900 might likewise include a read only memory (“ROM”) or other static storage device coupled to bus 902 for storing static information and instructions for processor 904.

The computing system 900 might also include one or more various forms of information storage mechanism 910, which might include, for example, a media drive 912 and a storage unit interface 920. The media drive 912 might include a drive or other mechanism to support fixed or removable storage media 914. For example, a hard disk drive, a floppy disk drive, a magnetic tape drive, an optical disk drive, a CD or DVD drive (R or RW), or other removable or fixed media drive might be provided. Accordingly, storage media 914 might include, for example, a hard disk, a floppy disk, magnetic tape, cartridge, optical disk, a CD or DVD, or other fixed or removable medium that is read by, written to or accessed by media drive 912. As these examples illustrate, the storage media 914 can include a computer usable storage medium having stored therein computer software or data.

In alternative embodiments, information storage mechanism 190 might include other similar instrumentalities for allowing computer programs or other instructions or data to be loaded into computing engine or logical circuit 900. Such instrumentalities might include, for example, a fixed or removable storage unit 922 and an interface 920. Examples of such storage units 922 and interfaces 920 can include a program cartridge and cartridge interface, a removable memory (for example, a flash memory or other removable memory engine) and memory slot, a PCMCIA slot and card, and other fixed or removable storage units 922 and interfaces 920 that allow software and data to be transferred from the storage unit 922 to computing engine or logical circuit 900.

Computing engine or logical circuit 900 might also include a communications interface 924. Communications interface 924 might be used to allow software and data to be transferred between computing engine or logical circuit 900 and external devices. Examples of communications interface 924 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 924 might typically be carried on signals, which can be electronic, electromagnetic (which includes optical) or other signals capable of being exchanged by a given communications interface 924. These signals might be provided to communications interface 924 via a channel 928. This channel 928 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 908, storage unit 920, media 914, and channel 928. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing engine or logical circuit 900 to perform features or functions of the disclosed technology as discussed herein.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent engine names other than those depicted herein can be applied to the various partitions.

Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “engine” does not imply that the components or functionality described or claimed as part of the engine are all configured in a common package. Indeed, any or all of the various components of an engine, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

I claim:

1. A system for pulsed hydroponic plant growth without using a media substrate to support plant roots comprises:
a growth platform, a mixing tank, and a hydraulic delivery system;
wherein the growth platform is shaped to form multiple apertures, each aperture configured to support a growth ring;
the hydraulic delivery system comprises sensors, a high pressure pump, multiple inline valves, and multiple micro-sprayers, the high pressure pump, inline valves, and micro-sprayers being hydraulically coupled to the mixing tank;
wherein the mixing tank is configured to combine nutrients in water to generate a nutrient solution for a nutrient solution mist;
wherein the micro-sprayers are located in proximity to one or more growth rings disposed within one or more apertures of the growth platform, the micro-sprayers being positioned to direct the nutrient solution mist towards one or more plants supported by the one or more growth rings; and
the hydraulic delivery system is configured to pulse the release of the nutrient solution mist during a feeding cycle at a selected pulse-width.

2. The system of claim 1, wherein the nutrient solution mist is released towards plant structures, based on the pulse-width, to feed and hydrate the one or more plants.

3. The system of claim 1, wherein the mixing tank keeps the nutrients separate from the water immediately before delivering in the nutrient solution to the one or more plants.

4. The system of claim 1, wherein the pulse-width and positioning of the nutrient solution mist are modified, based on readings of the sensor, in the hydraulic delivery system to promote pulsed hydroponic plant growth.
